(19) United States
(12) Patent Application Publication
(10) Pub. No.: US 2014/0062238 A1
(43) Pub. Date: Mar. 6, 2014

(54) MODULAR ELECTRICAL MACHINE

(71) Applicants: Markus Anton Mueller, Edinburgh (GB); Alasdair Stewart McDonald, Edinburgh (GB)

(72) Inventors: Markus Anton Mueller, Edinburgh (GB); Alasdair Stewart McDonald, Edinburgh (GB)

(21) Appl. No.: 13/602,707

(22) Filed: Sep. 4, 2012

(51) Int. Cl. H02K 1/27; H02K 7/116; H02K 9/00

(52) U.S. Cl. CPC H02K 1/2793; H02K 9/00; H02K 7/116
USPC 310/83; 310/156.36; 310/208

(57) ABSTRACT

A modular electrical machine includes multiple integrated rotor modules releasably mounted upon a power transmission member to form a torus-like structure, wherein each integrated rotor module includes a series of parallel rotor plates spaced apart to provide an air gap between successive rotor plates in the series. The rotor plates hold permanent magnets securely within the air gap. Corresponding stator modules, each made of multiple air-cored coils potted in a resin material to form a blade. Each blade is externally supported with respect to the rotor module and is positioned between the permanent magnets within one of the air gaps between successive rotor plates.

### BACKGROUND

Assembly and component manufacture of large diameter electrical machines is very challenging. Such machines are contemplated to provide multi-megawatt (MW) machines for wind energy, tidal energy and marine propulsion. In these applications the machine tends to be radial flux i.e. the flux flows at right angles to the shaft axis. In an iron cored machine large magnetic attraction forces exist between the stator and iron cores. Such forces have presented difficulties in developing satisfactory large machines. For a conventional iron cored machine a generator fault would require removal of the complete machine, involving specialist craneage.

### SUMMARY OF THE DISCLOSURE

In this disclosure is described an axial flux electrical machine comprising a plurality of integrated modules each having at least 2 coaxial stages. Each module provides a portion of a machine assembly. Each module may be adapted to be releasably mounted. The modules may be mounted upon a support structure. The support structure(s) may be permanent or replaceable parts of the axial flux electrical machine. Thus each module provides operational functionality and is configured to have a structure allowing handling thereof and mounting in a readily removable manner. Therefore, each module may be readily exchanged for overhaul or maintenance without requiring the electrical machine to be taken off site. Prior art machines are usually taken out of service for disassembly and repair. The disclosed design permits continued operation of the electrical machine even if one or more modules becomes defective since this may only affect power output marginally in the larger machines.

Each module may be of a trapezoidal shape. Each module may be a segment of a disc.

Each coaxial stage has rotor and stator components, and has an air gap to permit relative movement between the rotor and stator components. Permanent magnets may provided in one of the rotor and stator components, and coils may be provided in the corresponding other component.

A rotor module may be a self contained unit providing both electromagnetic and structural function. The rotor module may be cast to form a single casting providing spaced apart plate elements of the rotor module sharing a common connecting part. Alternatively, the rotor module may be manufactured from separate plates, appropriately spaced apart and fastened together at one end by a common mounting member. Releasable fastenings can be used to assemble the separate plates which may have surface structures to form a common mounting to complete the rotor module. Fasteners such as bolts and nuts may be used, the bolts being passed through corresponding bosses formed on near edge surfaces of the rotor plates to provide the common mounting. Internal connector sleeves may be positioned between the near edge surfaces of the rotor plates either instead of provision of bosses, or in addition to provision of bosses to provide additional spacing in the common mounting.

The rotor plates may hold permanent magnets securely within the air gap. The permanent magnets may be affixed to surfaces of the rotor module. The rotor module serves as a safe keeper for the affixed permanent magnets. Selected portions of the surfaces of plates making up the rotor module may be machined to provide slots for receiving the permanent magnet(s). Alternatively, a casting may be formed such that the slots have already been cast for the magnets when forming the plates defining spaced stages for the rotor.

The rotor modules may be configured to be releasably coupled to a power transmission member. The power transmission member may be part of a power transmission system. The power transmission system may be coupled to a prime mover of a power generation machine. The power transmission member may comprise a shaft.

A support upon which the rotor modules may be assembled may be of generally circular shape. The rotor support structure may be generally wheel shaped and may comprise a circular rim supported by radial arms mounted upon a shaft.

A stator module is configured to be operatively associated with the rotor module. The stator module may comprise a number of blades to cooperate with the corresponding rotor plates or rotor plate elements, and the blades are connected to a common stator connecting member to form a stator module assembly. Positioning of the blades of the stator module in air gaps in the corresponding spaced apart plates of the rotor module provides an operational configuration.

A stator can be modularised for positioning within a stage of the rotor module. The stator module may provide n coils for a multiphase electrical machine. The number of coils is variable but may be, for example, 3 or 6. A stator may have blades containing several air-cored coils potted in a curable resin material. Each air-cored coil may be a simple concentrated coil. A required number of the air-cored coils are juxtaposed in the same plane and may be potted in a curable resin such as epoxy to provide a structural blade form which can be handled and assembled with other components. In an embodiment of a 3-phase electrical machine each stator module contains 3 coils. In an embodiment of a 6 phase electrical machine, each stator module contains 6 coils, etc.

Use of air-cored coils facilitates manufacture and reduces handling difficulties during assembly due to the lack of magnetic attraction forces between the stator and rotor.

It will be appreciated that multiple configurations of rotor and stator are possible provided that relative motion of one with respect to the other can be reliably achieved. However, a multi stage axial flux topology with outer stator offers significant advantages in terms of manufacturing, and also in overhaul and maintenance.

In an axial flux machine the flux flows parallel to the shaft axis. Axial flux machines can be more compact than a correspondingly rated radial flux machine.

Typically an axial flux machine of the prior art consists of a two rotor discs with permanent magnets mounted thereon and a stator disc sandwiched between them, these discs all being coaxially mounted. Alternatively such an axial machine consists of two stator discs with a permanent magnet disc sandwiched between them.

U.S. Pat. No. 5,229,677 describes an electric propulsion motor for marine vehicles. The motor has an axial gap design with a disc shaped rotor and two disc shaped stators. The two stators are provided with armature windings that are fed by a controlled current source. The rotor magnetic field is provided by permanent magnets mounted on a rotor disc.

U.S. Pat. No. 6,002,193 refers to U.S. Pat. No. 5,229,677 and indicates that such motors have several drawbacks. The motors of U.S. Pat. No. 5,229,677 are constructed for a given power rating and manufacture of components is dedicated to that particular power rating, and thus not scalable. Therefore each machine is essentially custom made for its specific purpose and mass production of components is not enabled. Manufacture of each machine is also a lengthy process.

U.S. Pat. No. 6,002,193 describes a basic module for a discoidal machine. The module includes at least one stator sub assembly and a rotor sub assembly, which are coaxially arranged. The basic module, representing a single machine can be mounted on a shaft and further modules added to that shaft. According to an example cited in U.S. Pat. No. 6,002,193, if one module is 100 kW at 500 rpm, then two modules would be 200 kW at 500 rpm, 3 modules would 300 kW at 500 rpm and so on. From this one sees that scaling up in terms of power with this technology is only possible if the rotational speed remains the same. This solution too has its drawbacks.

In a wind turbine for example, the rotational speed decreases as the rating goes up, so technology proposed in U.S. Pat. No. 6,002,193 could not be applied to a direct drive wind turbine. If known gearbox systems were used then the gearbox ratio would have to change to meet the chosen speed of a module design. Further in terms of physical size each module is equal to the outer diameter of the machine, resulting in large heavy components. Each U.S. Pat. No. 6,002,193 module is essentially a generator in its own right. Transport and handling such large components could be challenging and involve risks which would be difficult to manage safely.

In an embodiment in accordance with the present disclosure, a modular electrical machine comprises a plurality of integrated rotor modules each having at least 2 coaxial rotor stages, and corresponding stator module assemblies operatively positioned in the respective rotor stages of the integrated rotor modules, wherein each integrated rotor module comprises a series of parallel rotor plates spaced apart to provide an air gap between successive rotor plates in the series, wherein the rotor plates comprise permanent magnets, and the modular electrical machine further comprises a plurality of stator modules, each stator module comprising a plurality of air-cored coils potted in a resin material to form a blade, each blade being externally supported with respect to the rotor module and wherein each blade is positioned between the permanent magnets within one of said air gaps between successive rotor plates.

In an embodiment in accordance with the present disclosure, a modular electrical machine comprises a power transmission member, and a plurality of integrated rotor modules releasably coupled to the power transmission member, wherein each integrated rotor module comprises a series of parallel rotor plates spaced apart to provide an air gap between successive rotor plates in the series, wherein the rotor plates comprise permanent magnets, and the modular electrical machine further comprises a plurality of stator modules, each stator module comprising a plurality of air-cored coils potted in a resin material to form a blade, each blade being externally supported with respect to a corresponding rotor module and wherein each blade is positioned between the permanent magnets within one of said air gaps between successive rotor plates.

In an embodiment in accordance with the present disclosure, a modular electrical machine comprises a shaft and a rotor support structure mounted thereon, and a plurality of integrated rotor modules releasably mounted upon the rotor support structure, wherein each integrated rotor module comprises a series of parallel rotor plates spaced apart to provide an air gap between successive rotor plates in the series, wherein the rotor plates comprise permanent magnets, and the modular electrical machine further comprises a plurality of stator modules, each stator module comprising a plurality of air-cored coils potted in a resin material to form a blade, each blade being externally supported with respect to the rotor support structure and wherein each blade is positioned between the permanent magnets within one of said air gaps between successive rotor plates.

The modular electrical machine may be configured to be coupled to a prime mover of a power generation machine directly or indirectly. The modular electrical machine may be coupled to a drive member of a prime mover of a power generation machine through a power transmission system. The power transmission system may comprise a single- or multi-stage gearbox.

The power generation machine may be a wind turbine.

Embodiments of an axial flux machine of the present disclosure will now be described with reference to the accompanying drawings.

### DESCRIPTION OF THE DRAWINGS

FIG. 1 shows a perspective view from above and to one side of a rotor module for a four stage axial flux electrical machine;

FIG. 2 shows a side view of the rotor module shown in FIG. 1;

FIG. 3 shows a view from above the rotor module shown in FIG. 1;

FIG. 4 shows a view from below the rotor module shown in FIG. 1;

FIG. 5 shows an end view of the rotor module shown in FIG. 1;

FIG. 6 shows a perspective view from above and to one side of a stator module assembly for a four stage axial flux electrical machine;

FIG. 7 shows a perspective view from above and from the opposite side of the stator module shown in FIG. 6;

FIG. 8 shows a side view of the stator module shown in FIG. 6;

FIG. 9 shows an end view of the stator module shown in FIG. 6;

FIG. 10 shows a view from below the stator module shown in FIG. 6;

FIG. 11 shows a perspective view from above and to one side of an operational arrangement of the rotor module shown in FIG. 1 with the stator module assembly shown in FIG. 6;

FIG. 12 shows a perspective view from the opposite side of the operational arrangement shown in FIG. 11;

FIG. 13 shows an end view of the operational arrangement shown in FIG. 11;

FIG. 14 shows a side view of the operational arrangement shown in FIG. 11;

FIG. 15 shows a view of the operational arrangement shown in FIG. 11 from above;

FIG. 16 shows a view of the operational arrangement shown in FIG. 11 from below;

FIG. 17 shows a perspective view of multiple combined rotor and stator modules forming a torus-like circular assembly;

FIG. 18 shows a schematic perspective view of a rotor module mounted on a circular support with a stator module juxtaposed for insertion; and

FIG. 19 shows a schematic perspective view of part of a circular support structure with cantilever support members for four stator modules.

### DESCRIPTION OF EMBODIMENTS

### Rotor Module

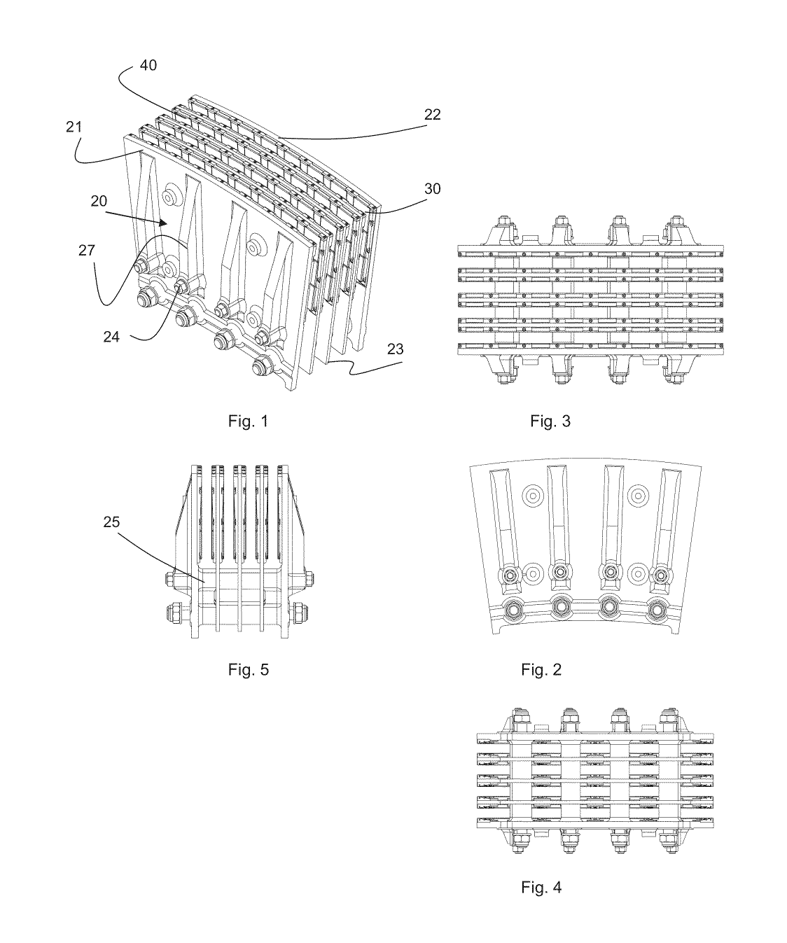

Referring to FIG. 1, a four stage rotor module 20 for an electrical machine is assembled from substantially parallel reinforced end plates 21, 22 and internal plates 23. The reinforced end plates 21, 22 each have strengthening ribs 27 which may be aligned with the radius of rotation in use. The reinforced end plate 21 and a juxtaposed internal plate 23 are mutually spaced to define an air gap 30. The respective internal plates 23 are also mutually spaced to define an equivalent air gap 30. In this way successive stages are integrated into a single rotor module. The internal surfaces of the reinforced end plates 21, 22, and the surfaces of the internal plates, between which the respective air gaps 30 are formed to support permanent magnets 40 confronting the air gap. The permanent magnets 40 may be recessed in support slots.

The reinforced end plates 21, 22 and internal plates 23 are integrated into a rotor module 20 by common fastening members 24 passing through corresponding bosses 25. In an alternative embodiment the spaced rotor plates with a common structural connection at one edge of the respective plates, are formed by casting a single unit.

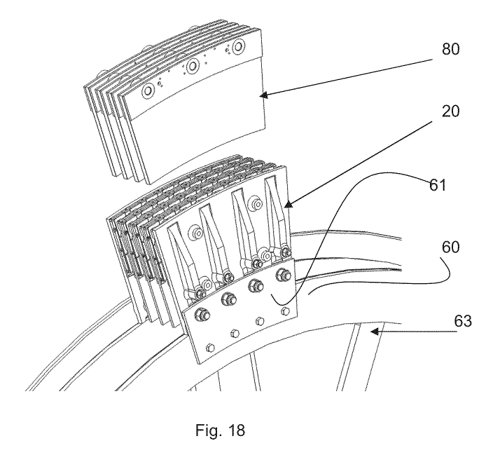

Referring to FIG. 18, the rotor module 20 may be mounted on a power transmission member, which in this embodiment, includes a separate support structure 60 to which the rotor module 20 is mounted by releasable fasteners using connecting plates 61. The separate support structure 60 may be formed as a wheel 63 having a rim and radial mounting arms extending from the rim and connected to a shaft. The rotor module 20 may be attached to the rim of the wheel 63. Multiple rotor modules 20 may be juxtaposed one to the next circumferentially around the rim, and likewise individually mounted using connecting plates 61.

### Stator Module Assembly

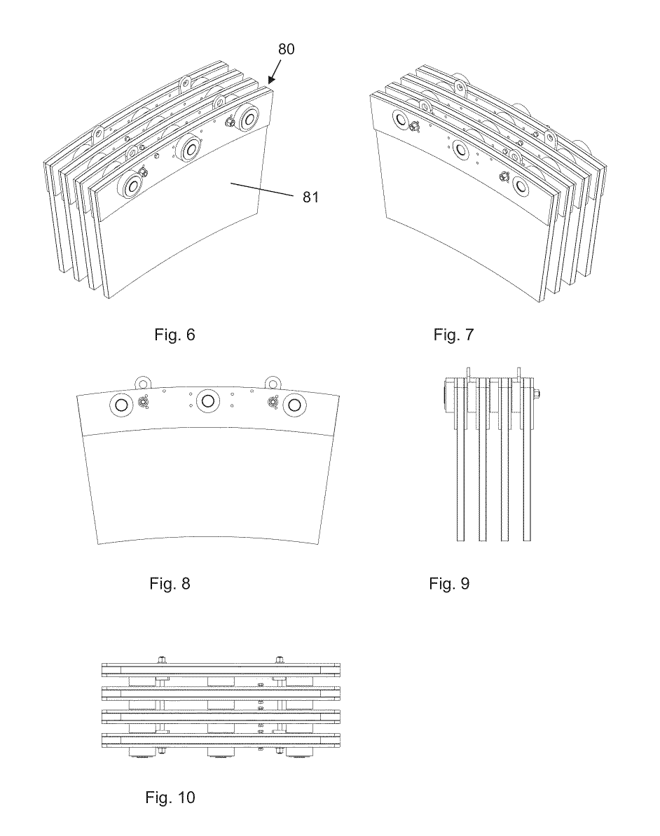

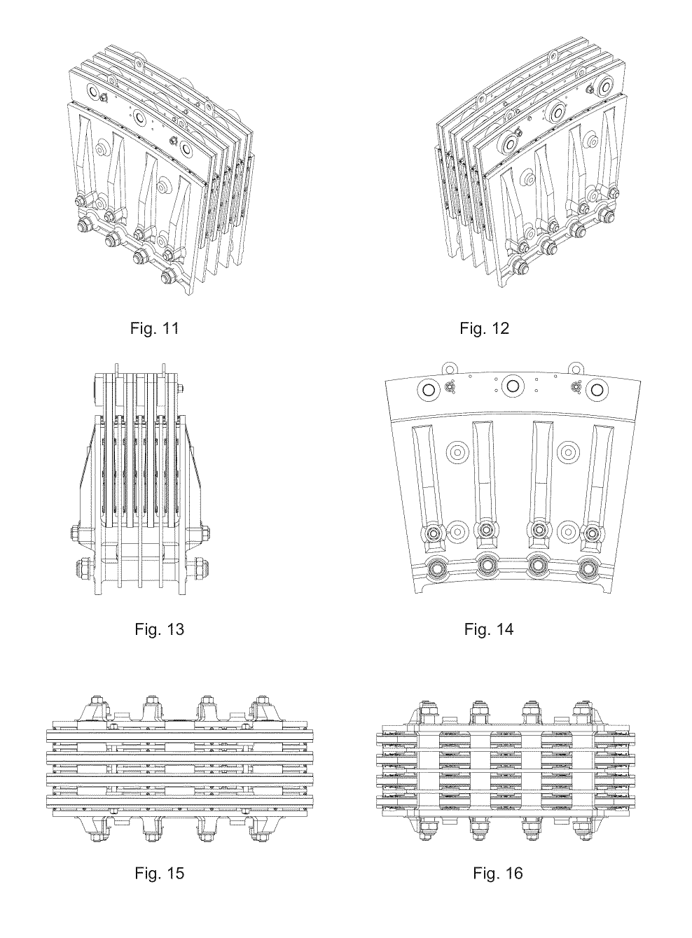

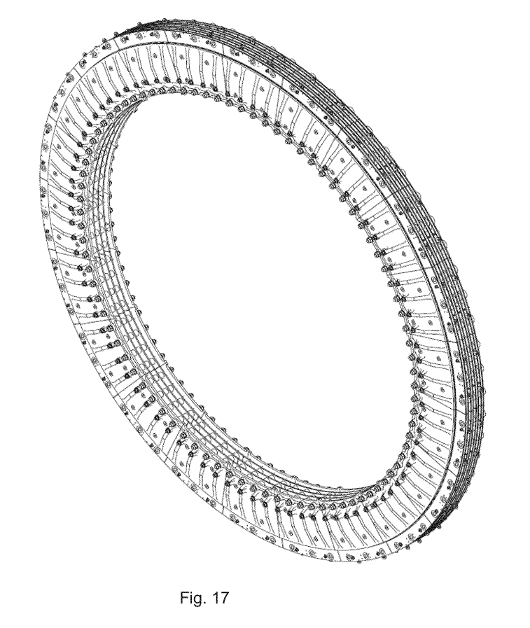

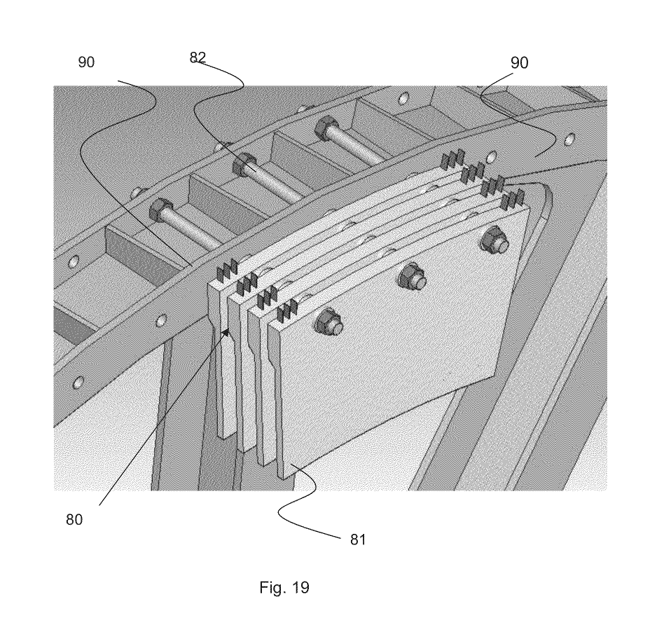

Referring now to FIG. 6, a stator module assembly 80 for a four stage axial flux electrical machine is assembled from air-cored coils potted in a curable resin to form a blade-form module component (hereinafter “blade”) 81. In this embodiment 3 air-cored copper concentrated coils are arranged in the same plane and potted in an epoxy resin for a 3 phase electrical machine to form the blade 81. Several blades 81 are associated in parallel, spaced apart, and fastened together to form the stator module assembly 80 using common stator connecting members 82. Referring to FIG. 19, the stator connecting members 82 may be of sufficient length to serve as cantilever mountings from a rim of a circular support structure 90.

Positioning of the blades 81 of the stator module assembly in the air gaps 30 in the corresponding spaced apart plates 21, 22, 23 of the rotor module 20 provides an operational configuration.

In use of such an embodiment, the stator support structure may be mounted in a housing in an operational relationship with the rotor support structure so that stator blades may be correctly positioned within the air gap between the rotor plates to provide a modular electrical machine.

The modular electrical machine may be coupled to a drive member of a prime mover of a power generation machine directly or indirectly through a power transmission system. The power transmission system may comprise a single- or multi-stage gearbox. The power generation machine may be a wind turbine.

Variations, modifications of the disclosed embodiments contemplated by the person skilled in the field are within the scope of the disclosure, and with regard to scope, attention is directed to the following claims which form part of the present disclosure and extend to all equivalents of the disclosed subject matter.

1. A modular electrical machine comprising a plurality of integrated rotor modules each having at least 2 coaxial rotor stages, and corresponding stator module assemblies operatively positioned in the respective rotor stages of the integrated rotor modules.

2. A modular electrical machine as claimed in claim 1, wherein each integrated rotor module comprises a series of parallel rotor plates spaced apart to provide an air gap between successive rotor plates in the series, wherein the rotor plates comprise permanent magnets, and the modular electrical machine further comprises a plurality of stator modules, each stator module comprising a plurality of air-cored coils potted in a resin material to form a blade, each blade being externally supported with respect to a corresponding rotor module, and wherein each blade is positioned between the permanent magnets within one of said air gaps between successive rotor plates.

3. A modular electrical machine comprising a power transmission member, and a plurality of integrated rotor modules releasably coupled to the power transmission member, wherein each integrated rotor module comprises a series of parallel rotor plates spaced apart to provide an air gap between successive rotor plates in the series, wherein the rotor plates comprise permanent magnets, and the modular electrical machine further comprises a plurality of stator modules, each stator module comprising a plurality of air-cored coils potted in a resin material to form a blade, each blade being externally supported with respect to a corresponding rotor module, and wherein each blade is positioned between the permanent magnets within one of said air gaps between successive rotor plates.

4. A modular electrical machine as claimed in claim 1, wherein each rotor module has a trapezoidal shape.

5. A modular electrical machine as claimed in claim 4, wherein each rotor module forms a segment of a disc.

6. A modular electrical machine as claimed in claim 1, wherein the rotor module is adapted to be releasably mounted upon a support structure.

7. A modular electrical machine as claimed in claim 1, wherein permanent magnets are mounted on surfaces of the rotor module.

8. A modular electrical machine as claimed in claim 1, wherein the rotor module comprises a single casting to provide spaced apart plate elements of the rotor module sharing a common connecting part.

9. A modular electrical machine as claimed in claim 1, wherein the rotor module comprises individual plates, appropriately spaced apart and fastened together at one end by a common mounting member.

10. A modular electrical machine as claimed in claim 9, wherein the common mounting member comprises a releasable fastener.

11. A modular electrical machine as claimed in claim 1, wherein the stator module assembly is externally mounted at the outside of the electrical machine.

12. A modular electrical machine as claimed in claim 11, wherein the stator module assembly is mounted using connecting members of sufficient length to serve as cantilever mountings from a rim of a circular support structure for the stator.

13. A modular electrical machine as claimed in claim 1, wherein the stator module assembly comprises a plurality of blades, each blade comprising a plurality of air-cored coils potted in a curable resin.

14. A modular electrical machine as claimed in claim 1, wherein the modular electrical machine is one of:
a direct drive electrical machine configured to be coupled directly to a prime mover of a power generation machine; and
an indirect drive electrical machine configured to be coupled to a prime mover of a power generation machine through a power transmission system.

15. A modular electrical machine as claimed in claim 14, wherein the power transmission system comprises a gearbox.

16. A modular electrical machine as claimed in claim 14, wherein the modular electrical machine is configured to be coupled to a prime mover of a wind turbine.

17. A modular electrical machine as claimed in claim 3, wherein each rotor module has a trapezoidal shape.

18. A modular electrical machine as claimed in claim 3, wherein the rotor module comprises a single casting to provide spaced apart plate elements of the rotor module sharing a common connecting part.

19. A modular electrical machine as claimed in claim 3, wherein the rotor module comprises individual plates, appropriately spaced apart and fastened together at one end by a common mounting member.

20. A modular electrical machine as claimed in claim 3, wherein the modular electrical machine is one of:
a direct drive electrical machine configured to be coupled directly to a prime mover of a power generation machine; and
an indirect drive electrical machine configured to be coupled to a prime mover of a power generation machine through a power transmission system.
